(19) United States
(12) Patent Application Publication
(10) Pub. No.: US 2014/0085904 A1
(43) Pub. Date: Mar. 27, 2014

(54) LED LIGHT FIXTURE

(71) Applicant: CASTER LIGHTING INC., Dongguan (CN)

(72) Inventors: Frank TSAO, Dongguan (CN); Yanchao HU, Dongguan (CN)

(73) Assignee: CASTER LIGHTING INC., Dongguan (CN)

(21) Appl. No.: 13/680,293

(22) Filed: Nov. 19, 2012

(30) Foreign Application Priority Data
Sep. 25, 2012 (CN) 201220492099.8

(51) Int. Cl. F21V 21/40; F21V 31/00; F21V 29/00; F21V 7/04

(52) U.S. Cl. CPC F21V 21/40; F21V 7/048; F21V 31/005; F21V 29/004
USPC 362/296.05; 362/399

(57) ABSTRACT

The invention discloses an LED light fixture, which comprises a lamp body and a lamp handle connected therewith, wherein the lamp body adopts an AC (Alternating Current) LED as a light source. As the LED light fixture does not need a power supply, the light fixture has the advantages of being small, having a simple structure and saving materials; as a plurality of small planes are used for forming a complete multi-stage sagittal reflecting surface, the light fixture has higher reflection efficiency; as a gland strip and a shielding mechanism are adopted, the reverse side of the product has a complete structure and is lightproof; as non-through screwed connection holes are formed at positions of the lamp body, at which the lamp body is connected with the lamp handle, the light fixture has superior sealability and watertightness.

### FIELD OF THE INVENTION

The invention relates to the technical field of lighting, in particular to an LED light fixture.

### BACKGROUND OF THE INVENTION

Currently, all the traditional LED light fixtures adopt the design concept of the traditional light fixtures. The structure of the traditional LED light fixture is mainly as follows: 1. an DC (Alternating Current) LED is adopted as a light source and an LED power supply is used for power supply, so that the problems of the mounting means, mounting space and mounting position of the power supply must be solved in the case of design, wherein two means are usually adopted in the prior art to solve the problems: one is to additionally arrange an electrical box on the outside of a lamp body to fix and mount the LED power supply, and the other is to increase the volume of the lamp body and additionally set positions in the lamp body to fix and mount the LED; 2. the traditional LED light fixture follows the design of the traditional light-source light fixture and has a stiff structure and low light output conversion efficiency; 3. the details of the shape of a front structure are paid attention but the glass edge of the light fixture is exposed on the reverse side of the light fixture, and then apertures may be formed on the reverse side of the lamp body as the glass edge is affected by refracted light when the light fixture is lighted; 4. a fixing groove for mounting a gland strip is formed on the opening edge of the lamp body to mount the gland strip, and a piece of glass of which the area is more than that of the fixing groove is used for covering the gland strip and a lamp door is used for impacting the glass on the gland strip, so that the glass can be firmly connected with the lamp body; 5. a penetrating and tapping hole is directly drilled on the lamp body for the connection and fixation of the handle and the lamp body and the handle is fixed on the lamp body via screwing-in and impaction, so that the sealability and watertightness of the lamp body are poor; the handle is usually fixed on the outmost surface of the lamp body on the light fixture and directly fixed via screws, so that the overall structure of the light fixture is not integrated in visual sensation and connecting points between the handle and the lamp body are abrupt, and thus the overall shape can be affected; and 6. when the light fixture is connected with an external power network, a terminal box may be additionally arranged outside the lamp body for the safe and functional requirements of electrical connection.

As the traditional LED light fixture adopts the above structure, the traditional LED light fixture has the technical defects that: 1. as the mounting position of the power supply must be considered, the light fixture has large dimension and complex overall structure and the materials are wasted; 2. the design structure of a reflector is stiff and the reflection efficiency is low; 3. the product is not complete in structure seen from the reverse side and is not lightproof; 4. due to the fixing and processing of the handle, the sealability and watertightness of the light fixture may be degraded; 5. due to the unreasonable fixing positions of the handle, the completeness of the overall shape of the entire product may be damaged; and 6. due to the additional arrangement of the terminal box, the materials are wasted and the outline of the overall structure of the lamp body is affected.

### SUMMARY OF THE INVENTION

The technical problem to be solved by the invention is to provide an LED light fixture having the advantages that: the materials used are few; the reflection efficiency of a reflector is high; the reverse side of the light fixture is lightproof; the sealability at positions, at which the light fixture is connected with a handle, is good; and the structure is simple and a terminal box is not required.

In order to solve the technical problem, the invention provides an LED light fixture, which comprises a lamp body and a lamp handle connected therewith, wherein the lamp body adopts an AC (Alternating Current) LED as a light source.

A preferred technical proposal of the invention is that: the lamp body adopts arc-shaped cooling fins with different dimensions and radians to form an outline of the lamp body.

Further preferred technical proposal of the invention is that: a gland strip is also arranged on the outer edge of a mounting groove of the lamp body; and a circle of shielding mechanism is also arranged on the outer edge of a mounting groove of the gland strip for the lamp body.

Further preferred technical proposal of the invention is that: the lamp body is also provided with a reflector which adopts a plurality of small planes to form a complete multi-stage sagittal reflecting surface.

Further preferred technical proposal of the invention is that: the lamp handle is connected with the lamp body via screws; non-through screwed connection holes are formed at positions of the lamp body, at which the lamp body is connected with the lamp handle; positions of the lamp handle, at which the lamp handle is connected with the outside of the lamp body, are disposed inside gaps of cooling fins of the lamp body; and a terminal box is also arranged inside the lamp body.

As the LED light fixture does not need a power supply, the light fixture has the advantages of being small, having a simple structure and saving the materials; as a plurality of the small planes are used for forming the complete multi-stage sagittal reflecting surface, the light fixture has higher reflection efficiency; as the gland strip and the shielding mechanism are adopted, the reverse side of the product has a complete structure and is lightproof; as the non-through screwed connection holes are formed at the positions of the lamp body, at which the lamp body is connected with the lamp handle, the light fixture has superior sealability and watertightness; as the positions of the lamp handle, at which the lamp handle is connected with the outside of the lamp body, are disposed inside the gaps of the cooling fins for the lamp body, the light fixture has complete and beautiful overall shape; and as the terminal box is arranged inside the lamp body, the overall structure of the lamp body is not complex.

### BRIEF DESCRIPTION OF THE DRAWINGS

FIG. 1 is a front view of an LED light fixture provided by the invention; and

FIG. 2 is a rear view of the LED light fixture provided by the invention.

### DETAILED DESCRIPTION OF THE PREFERRED EMBODIMENTS

Detailed description is given to the preferred embodiments of the invention with the attached drawings.

### Embodiment

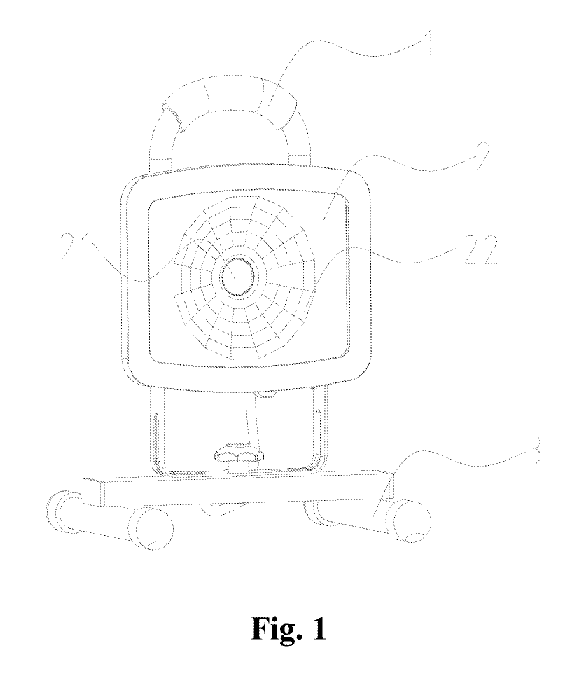

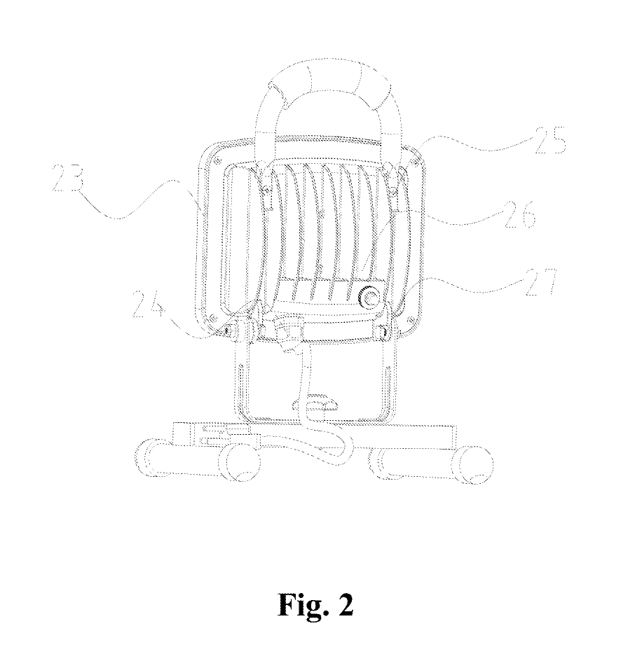

As illustrated in FIGS. 1 and 2 (FIGS. 1 and 2 are structure diagrams of an LED light fixture provided by the invention), the LED light fixture provided by the invention comprises a lamp body 2, a lamp handle 1 connected with the lamp body 2 via screws 25, and a pedestal 3 connected with the lamp body 2 via bolts 27.

As for LED light fixtures adopting DC (Direct Current) LEDs as light sources, as the civil power in the world is mainly 50 or 60 HZ AC (Alternating Current) currently and the power supply voltage of residential lighting systems is between 100 and 277V, the LED light fixture adopting the DC LED as the light source must adopt a power supply to convert high-voltage commercial AC into low-voltage DC and the current must be controlled and stably supplied to the LED. Therefore, the LED light fixture adopting the DC LED as the light source must have an LED power supply; the mounting space and mounting position of the power supply must be preserved in the case of lamp fixture design; and the mounting means of the power supply must be also considered.

The lamp body 2 of the LED light fixture provided by the invention adopts an AC LED as a light source, is applied to watertight light fixtures using civil power, directly uses commercial AC, and does not need an LED power supply. Therefore, the structure of the lamp body is simplified; the volume of the light fixture and the amount of materials used are reduced; and convenience is provided for the shape design of the lamp body.

As illustrated in FIG. 1, the invention adopts a unique optical design means, namely adopting a plurality of reflecting surfaces 22 to form a complete multi-stage sagittal reflecting surface 21. The light emitted by the light source is effectively reflected to the outside of the light fixture from a plurality of angles according to the characteristics of the LED light source, so that the light output conversion efficiency of a reflector is improved and the traditional stiff structure is modified in the aspect of shape.

As illustrated in FIG. 2, as for the LED light fixture provided by the invention, a gland strip 23 for the lamp body is mounted inside a sealing groove, and a shielding mechanism is arranged on the circumference of a fixing groove of the gland strip for the lamp body to form a circle of shielding mechanism, so that the glass edge is lightproof. Moreover, the glass edge is tightly engaged with a lamp door, so that the phenomenon of light leakage on the reverse side of the light fixture can be avoided.

The light fixture provided by the invention adopts the reasonable design of the lamp body 2, namely the thickness of corresponding points of the lamp body 2, at which the handle 1 is fixed on the lamp body 2, is increased, so that a processing hole cannot penetrate through the lamp body 2, and thus the sealability and watertightness of the light fixture can be guaranteed. Therefore, the problem of poor sealability and watertightness of the lamp body as one or more penetrating holes may be processed at positions of the lamp body, at which the lamp handle and the lamp body are connected and fixed with each other, to lock screws due to the requirement of handle fixing can be avoided.

As illustrated in FIG. 2, the lamp body of the light fixture provided by the invention adopts a plurality of arc-shaped cooling fins with different dimensions and radians to form an outline of the lamp body. Fixing points of the handle 2 are not disposed on the external surface of the lamp body 2 but on the inside of the gaps of the cooling fins 26, so that the handle 1 and the lamp body 2 are integrated into a whole as seen from the overall structure. Therefore, the problem that the overall structure of a light fixture is not integrated in visual sensation and connecting points between a handle and a lamp body are abrupt as the handle for the traditional light fixture is usually fixed on the outmost surface of the lamp body on the light fixture can be avoided.

As illustrated in FIG. 2, the light fixture provided by the invention adopts the design of combining a terminal box 24 and the lamp body 2 together, wherein a space required for wiring is designed on the inside of the lamp body 2 to form the compact, light and handy lamp body, in which the terminal box 24 is integrated into a whole with the lamp body 2. Therefore, the light fixture has simple overall outline and smooth lines and the amount of materials used is also reduced. And consequently, the problems of affecting the overall shape of the lamp body and increasing the amount of materials used as a terminal box is additionally arranged outside the lamp body of the traditional light fixture for the safe and functional requirements of electric connection when the light fixture is connected with an external power network can be avoided.

The lamp body of the light fixture provided by the invention designed on the basis of the modification has a simple structure and smooth lines, so that raw materials required by the lamp body can be obviously saved. The lamp body is adapted to handles with various structures to meet different requirements. Moreover, the lamp body is also adapted to various mounting brackets, so as to be adapted to different holders and other mounting requirements.

It shall be finally noted that the above is only preferred embodiments of the invention and not intended to limit the technical proposal of the invention and equivalent replacements or corresponding modifications made on the technical characteristic of the invention shall be still within the scope of protection of the invention.

What is claimed is:

1. An LED light fixture, comprising a lamp body and a lamp handle connected therewith, wherein the lamp body adopts an AC LED as a light source.

2. The LED light fixture according to claim 1, wherein the lamp body adopts arc-shaped cooling fins with different dimensions and radians to form an outline of the lamp body.

3. The LED light fixture according to claim 1, wherein a gland strip is also arranged on the outer edge of a mounting groove of the lamp body; and a circle of shielding mechanism is also arranged on the outer edge of a mounting groove of the gland strip for the lamp body.

4. The LED light fixture according to claim 1, wherein the lamp body also has a reflector which adopts a plurality of small planes to form a complete multi-stage sagittal reflecting surface.

5. The LED light fixture according to claim 1, wherein the lamp handle is connected with the lamp body via screws.

6. The LED light fixture according to claim 1, wherein non-through screwed connection holes are formed at positions of the lamp body, at which the lamp body is connected with the lamp handle.

7. The LED light fixture according to claim 1, wherein positions of the lamp handle, at which the lamp handle is connected with the outside of the lamp body, are disposed inside gaps of the cooling fins for the lamp body.

8. The LED light fixture according to claim 1, wherein a terminal box is arranged inside the lamp body.
